(19) United States
(12) Patent Application Publication
(10) Pub. No.: US 2007/0247400 A1
(43) Pub. Date: Oct. 25, 2007

(54) Control method of display apparatus

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/785,021

(22) Filed: Apr. 13, 2007

(30) Foreign Application Priority Data
Apr. 19, 2006 (TW) 095113999

(51) Int. Cl. G09G 3/32

(52) U.S. Cl. 345/83

(57) ABSTRACT

A control method of a display apparatus. The display apparatus includes a light source module for generating at least one first light source and a second light source, and a display plane for displaying at least one image frame, which has a first sub-frame and a second sub-frame. The control method includes the steps of displaying an image of the first sub-frame on the display plane during a first time, and displaying an image of the second sub-frame on the display plane with a first distance from the image of the first sub-frame during a second time.

### CROSS REFERENCE TO RELATED APPLICATIONS

This Non-provisional application claims priority under 35 U.S.C. §119(a) on Patent Application No(s). 095113999 filed in Taiwan, Republic of China on Apr. 19, 2006, the entire contents of which are hereby incorporated by reference.

### BACKGROUND OF THE INVENTION

1. Field of Invention

The invention relates to a control method of a display apparatus, and, in particular, to a control method applied to a display apparatus for displaying an image frame.

2. Related Art

Currently, the main display apparatuses may be classified into a self-emissive display apparatus and a non-self-emissive display apparatus. The self-emissive display apparatus includes, for example, a cathode ray tube (CRT) display and a plasma display panel (PDP), while the non-self-emissive display apparatus includes, for example, a liquid crystal display (LCD) and a digital light processing (DLP) projector.

The non-self-emissive display apparatus needs a light source module for generating at least one light source, and displays a color on a display plane according to one light source in conjunction with a pixel array. Typically, the color may be displayed using a color filter to split the light source into red, green and blue light beams, which may be displayed on the display plane in an overlapped manner. Alternatively, the red, green and blue light beams may be projected onto the display plane so that the color may be displayed on the display plane.

The above-mentioned displaying method can achieve the object of color display only in conjunction with a typical liquid crystal. Generally speaking, the response time of this liquid crystal is about 10 ms to 15 ms. Recently, the manufacturers have constructively spent a lot of resources to improve the response speed of the liquid crystal, and thus developed the optically compensated bend (OCB) liquid crystal technology having the shortened response time shorter than 10 ms.

Based on the increase of the response speed of the liquid crystal, the manufacturer also develops a color circulating display using a circulating light source according to the property of the OCB liquid crystal, and the color may be displayed on the display plane according to the phenomenon of the persistence of vision of the human eyes. In general, the image is composed of three primary-color light sources including red, green and blue light sources, and the frame may be displayed on the display plane in conjunction with the gray-scale adjustment of the liquid crystal. The so-called color circulating display technology is to divide one image frame data zone into the image frame data corresponding to the red light source, the green light source and the blue light source, and the image frame data may be displayed on the display plane according to the phenomenon of the persistence of vision of the human eyes.

If the color circulating display technology mentioned hereinabove has the light emitting diode as the backlight source, the color filter may be eliminated from the display apparatus so that the cost can be effectively reduced. However, when the color circulating display technology is utilized and when an object is moving on a frame of a display plane of the display apparatus, the color split phenomenon often occurs on the edge of the moving object because the human eyes has predicted the frame motion and thus tracked the image. That is, the red, green and blue colors may be observed on the edge of the moving object so that the utility of the color circulating technology is restricted.

As mentioned hereinabove, the user's demand on the image is getting higher and higher. So, it is an important subject of the invention to provide a control method capable of effectively suppressing the color split phenomenon generated by the display apparatus using the color circulating display technology.

### SUMMARY OF THE INVENTION

In view of the foregoing, the invention is to provide a control method of a display apparatus capable of preventing a color split phenomenon.

To achieve the above, the invention discloses a control method of a display apparatus. The display apparatus includes a light source module for generating at least one first light source and a second light source, and a display plane for displaying at least one image frame having a first sub-frame and a second sub-frame. The control method includes the steps of: displaying an image of the first sub-frame on the display plane during a first time; and displaying an image of the second sub-frame on the display plane with a first distance from the image of the first sub-frame during a second time.

As mentioned hereinabove, the control method of the display apparatus according to the invention divides the image frame into the first sub-frame and the second sub-frame, which are sequentially displayed on the display plane with a period of time and a distance between images thereof. The human eyes having the phenomenon of the persistence of vision may watch the image frame. Consequently, it is possible to prevent the human eyes from tracking the moving image and thus to prevent the color split phenomenon from happening.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a control method of a display apparatus according to a preferred embodiment of the invention, wherein a moving object moves by a distance in a first image frame and a second image frame;

FIG. 2 is a flow chart showing the control method of the display apparatus according to the preferred embodiment of the invention; and

FIGS. 3A to 3D are schematic illustrations showing the moving object in a first sub-frame, a second sub-frame and a third sub-frame, which are sequentially displayed on a display plane according to the flow chart of FIG. 2.

### DETAILED DESCRIPTION OF THE INVENTION

The present invention will be apparent from the following detailed description, which proceeds with reference to the accompanying drawings, wherein the same references relate to the same elements.

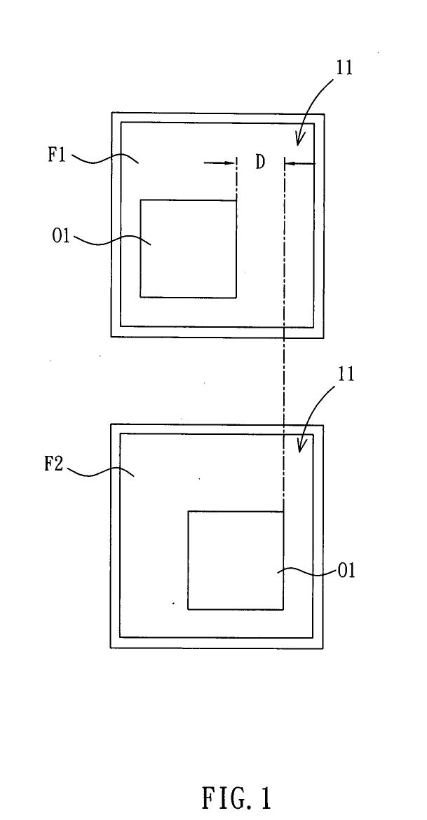

First, it is to be explained that the control method of the display apparatus according to the preferred embodiment of the invention is applied to a light source module in conjunction with a display plane 11. In this illustrated embodiment, the light source module generates a first light source, a second light source and a third light source (not shown). The display plane 11 sequentially displays a first image frame F1 and a second image frame F2, wherein each of the first image frame F1 and the second image frame F2 has a moving object O1 moving by a distance D (see FIG. 1) on the display plane 11.

In this embodiment, the display apparatus is a non-self-emissive display apparatus, which may be a LCD apparatus or a DLP projecting device. In addition, the first light source, the second light source and the third light source may be respectively a red light source, a green light source and a blue light source. Each of the light sources includes at least one light emitting diode. Of course, the first light source, the second light source or the third light source may also be a white light source filtered by a color filter so that the required color of light source is generated. Furthermore, the first image frame F1 and the second image frame F2 are displayed on the display plane 11 with the frequency of 60 Hz. In other words, each frame period is about 16.67 ms (microseconds), and the display apparatus writes the image frame data of the image frame to a pixel array of the display apparatus in each frame period so that the image frame can be displayed on the display plane 11 in conjunction with the backlight source and the liquid crystal gray-scale adjustment.

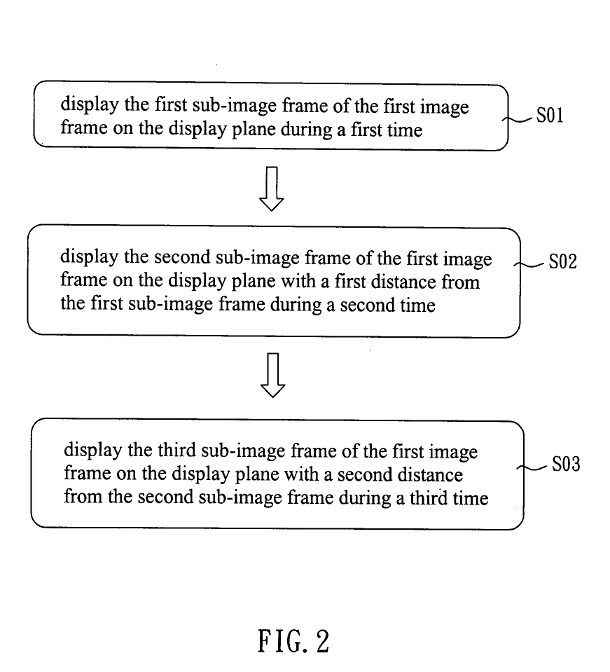

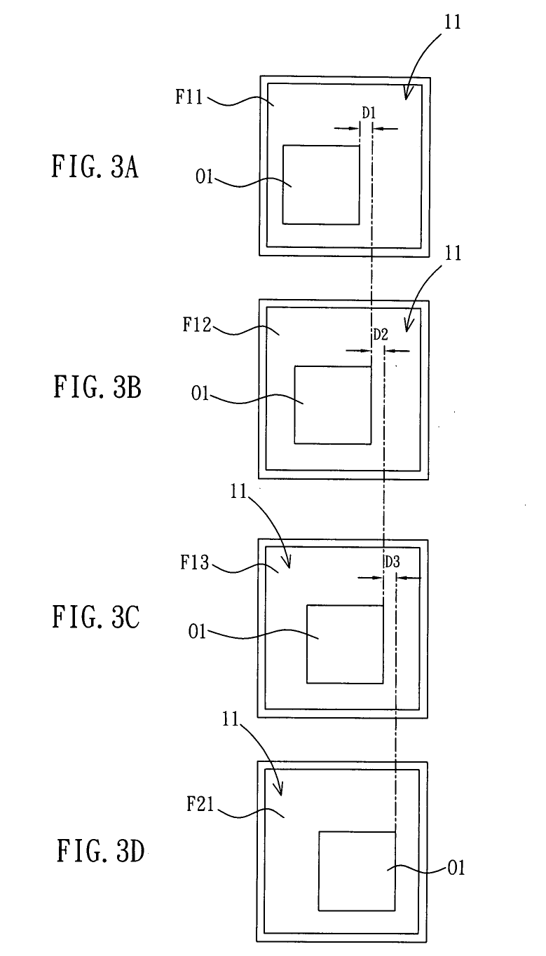

Referring to FIG. 2, the control method of the display apparatus according to the preferred embodiment of the invention includes steps S01 to S03. The first image frame F1 is divided into a first sub-frame F11, a second sub-frame F12 and a third sub-frame F13 (see FIGS. 3A to 3C), which are respectively the sub-frame data corresponding to the red light source, the sub-frame data corresponding to the green light source and the sub-frame data corresponding to the blue light source. In other words, each color of light source corresponds to one sub-frame. When the number of the colors of light sources is greater, the image frame will be divided into more sub-frames. In addition, when the moving object O1 continues moving in the next image frame, such as the second image frame F2, the second image frame F2 is also divided into the sub-frame corresponding to the red light source, the sub-frame corresponding to the green light source and the sub-frame corresponding to the blue light source. In this embodiment, only the first sub-frame F21 of the second image frame F2 is displayed, as shown in FIG. 3D.

As shown in FIG. 3A, step S01 is performed to display an image of the first sub-frame F11 of the first image frame F1 on the display plane 11 during a first time. In this embodiment, the display apparatus writes the sub-frame data of the image in the first sub-frame F11 of the first image frame F1 to the pixel array of the display apparatus during the first time, and turns on the first light source (red light source) so that the image of the first sub-frame F11 of the first image frame F1 is displayed on the display plane 11.

As shown in FIG. 3B, step S02 is performed to display the image of the second sub-frame F12 of the first image frame F1 on the display plane 11 with a first distance D1 from the image of the first sub-frame F11 during a second time. In this embodiment, the display apparatus writes the sub-frame data of the image in the second sub-frame F12 of the first image frame F1 to the pixel array of the display apparatus during the second time, and turns on the second light source (green light source) so that the image of the second sub-frame F12 of the first image frame F1 may be displayed on the display plane 11.

As shown in FIG. 3C, step S03 is performed to display the image of the third sub-frame F13 of the first image frame F1 on the display plane 11 with a second distance D2 from the image of the second sub-frame F12 during a third time. In this embodiment, the display apparatus writes the sub-frame data of the image in the first sub-frame F13 of the first image frame F1 to the pixel array of the display apparatus during the third time, and turns on the third light source (blue light source) so that the image of the third sub-frame F13 of the first image frame F1 is displayed on the display plane 11.

As shown in FIG. 3D, the image of a first sub-frame F21 of the second image frame F2 is displayed on the display plane 11 with a third distance D3 from the image of the third sub-frame F13 during a fourth time. In this embodiment, the display apparatus writes the sub-frame data of the image in the first sub-frame F21 of the second image frame F2 to the pixel array of the display apparatus during the fourth time, and turns on the first light source (red light source) so that the image of the first sub-frame F21 of the second image frame F2 may be displayed on the display plane 11.

In this embodiment, the first sub-frame F11, the second sub-frame F12 and the third sub-frame F13 constitute the first image frame, each sub-frame is displayed on the display plane 11 with the frequency of 180 Hz, and each sub-frame data is written to the pixel array of the display apparatus with the frequency of 180 Hz. Of course, when the image frames are respectively divided into different numbers of sub-frames, the display frequency thereof has to be properly adjusted. In addition, the first distance D1, the second distance D2 and the third distance D3 are the same. In other words, the control method of the display apparatus according to this embodiment equally divides the distance D, which is moved by the image (the moving object 01) in the first image frame F1 and the second image frame F2, into three distances D/3, moves the image (moving object 01) of the first sub-frame F11, the second sub-frame F12 and the third sub-frame F13 of the first image frame F1 by the distance of D/3 during the first time, the second time and the third time, respectively, and then displays images of frames on the display plane 11.

In summary, when the image frame has the moving object, the control method of the display apparatus according to the invention divides the image frame into the first sub-frame, the second sub-frame and the third sub-frame. In addition, the light source control and the liquid crystal gray-scale adjustment are performed, and the images of the frames are sequentially displayed on the display plane with a time interval and a distance so that the image frames may be observed according to the phenomenon of the persistence of vision of the human eyes. Consequently, the zones of the moving object in each sub-frame corresponding to the retinas of the human eyes may overlap with each other. Thus, it is possible to prevent the human eyes from tracking the moving object to cause the color split phenomenon, and thus to enhance the utility of the non-self-emissive display apparatus using the color circulating display technology.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A control method of a display apparatus, the display apparatus comprising a light source module for generating at least one first light source and a second light source, and a display plane for displaying at least one image frame having a first sub-frame and a second sub-frame, the control method comprising the steps of:
displaying an image of the first sub-frame on the display plane during a first time; and
displaying an image of the second sub-frame on the display plane with a first distance from the image of the first sub-frame during a second time.

2. The control method according to claim 1, wherein the display apparatus writes image frame data of the image of the first sub-frame to a pixel array of the display plane during the first time.

3. The control method according to claim 2, wherein the light source module turns on the first light source during the first time.

4. The control method according to claim 1, wherein the display apparatus writes image frame data of the image of the second sub-frame to a pixel array of the display plane during the second time.

5. The control method according to claim 4, wherein the light source module turns on the second light source during the second time.

6. The control method according to claim 1, wherein each of the first light source and the second light source is selected from at least one of the group consisting of a red light source, a green light source, a blue light source and a white light source.

7. The control method according to claim 1, wherein each of the first light source and the second light source comprises at least one light-emitting diode.

8. The control method according to claim 1, wherein the light source module further comprises a third light source, and the control method further comprises the step of:
displaying an image of a third sub-frame on the display plane with a second distance from the image of the second sub-frame during a third time.

9. The control method according to claim 8, wherein the display apparatus writes image frame data of the image of the third sub-frame to a pixel array of the display plane during the third time.

10. The control method according to claim 9, wherein the light source module turns on the third light source during the third time.

11. The control method according to claim 8, wherein the third light source is selected from at least one of the group consisting of a red light source, a green light source, a blue light source and a white light source.

12. The control method according to claim 8, wherein the third light source comprises at least one light-emitting diode.

13. The control method according to claim 8, wherein the first distance is equal to the second distance.

14. The control method according to claim 8, wherein the image of the first sub-frame, the image of the second sub-frame and the image of the third sub-frame are respectively written to a pixel array of the display apparatus with a frequency of 180 Hz.

15. The control method according to claim 1 being applied to a liquid crystal display apparatus.

16. The control method according to claim 1 being applied to a digital light processing projecting device.
